(19) United States
(12) Patent Application Publication
(10) Pub. No.: US 2019/0196676 A1
(43) Pub. Date: Jun. 27, 2019

(54) SYSTEM AND METHOD FOR DYNAMICALLY LOADED APPLICATION/AGENT TERMINAL INTEGRATION

(71) Applicant: Avaya Inc., Santa Clara, CA (US)

(72) Inventors: Brian Hillis, Centennial, CO (US); Pier Angelo Tognini Filho, Castle Rock, CO (US); Renato Simoes, Petrolina (BR); Diego Alonso Klajner, Parkland, FL (US)

(21) Appl. No.: 15/854,543

(22) Filed: Dec. 26, 2017

(51) Int. Cl. G06F 3/0483; H04L 29/06; H04L 29/08; H04M 3/51

(52) U.S. Cl. CPC G06F 3/0483; H04L 65/1006; H04L 67/02; H04M 2201/42; H04M 3/5191; H04M 3/5133; H04L 67/146

(57) ABSTRACT

A dynamically loadable application (e.g., a networked application, such as a Back-to-Back User Agent (B2BUA)) receives a Session Initiation Protocol (SIP) message. For example, the SIP message may be an incoming SIP INVITE message to establish a communication session between a communication endpoint and an agent terminal in a contact center. The dynamically loadable application attaches information to the SIP message. The attached information is for adding additional graphical user interface element(s) on the agent terminal. The dynamically loadable application sends the SIP message with the attached information to the agent terminal. The agent terminal then uses the attached information to display additional graphical user interface element(s) on the agent terminal. For example, the graphical user interface element may be a new call recording button. The additional graphical user interface element(s) allow new functionality to be added to the agent terminal without modification of the existing agent terminal software.

### BACKGROUND

Traditional contact center solutions provide contact center agents with mechanisms to gain access to contextual information about incoming/outgoing calls. These mechanisms may include, Automatic Number Identification (ANI), Dialed Number Identification Service (DNIS), collected digits (through a self-service Interactive Voice Response (IVR) application), and User-to-User Information (UUI). Information that is associated with the call can be used as a key to perform a screen pop to that contains relevant information for the call (e.g., customer records). The interaction and contextual information presented to the agent by the mechanism is static and typically associated with a call event (e.g., ringing, answered call, et cetera).

The problem with static processes is that they cannot be implemented without major changes to the communication infrastructure and the agent terminal. For example, if a new service needs to be implemented, both the agent terminal and the communication infrastructure need to be updated to support the new feature. This leads to long and costly development cycles as new features are added.

### SUMMARY

These and other needs are addressed by the various embodiments and configurations of the present disclosure. A dynamically loadable application (e.g., a networked application, such as a Back-to-Back User Agent (B2BUA)) receives a Session Initiation Protocol (SIP) message. For example, the SIP message may be an incoming SIP INVITE message to establish a communication session between a communication endpoint and an agent terminal in a contact center. The dynamically loadable application attaches information to the SIP message. The attached information is for adding additional graphical user interface element(s) on the agent terminal. The dynamically loadable application sends the SIP message with the attached information to the agent terminal. The agent terminal then uses the attached information to display additional graphical user interface element(s) on the agent terminal. For example, the graphical user interface element may be a new call recording button. The additional graphical user interface element(s) allow new functionality to be added to the agent terminal without modification of the existing agent terminal software.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “Session Initiation Protocol” (SIP) as used herein refers to an IETF-defined signaling protocol, widely used for controlling multimedia communication sessions such as voice and video calls over Internet Protocol (IP). The protocol can be used for creating, modifying and terminating two-party (unicast) or multiparty (multicast) sessions consisting of one or several media streams. The modification can involve changing addresses or ports, inviting more participants, and adding or deleting media streams. Other feasible application examples include video conferencing, streaming multimedia distribution, instant messaging, presence information, file transfer and online games. SIP is as described in RFC 3261, available from the Internet Engineering Task Force (IETF) Network Working Group, November 2000; this document and all other SIP RFCs describing SIP are hereby incorporated by reference in their entirety for all that they teach.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for managing integration between dynamically loaded applications and agent terminals.

FIG. 2 is a flow diagram of an exemplary incoming SIP call flow in a contact center.

FIG. 3 is a flow diagram of an exemplary outgoing SIP call flow in a contact center.

FIG. 4 is a flow diagram of a process for sending messages from a dynamically loaded application to an agent terminal.

FIG. 5 is a flow diagram of a process for receiving messages from a dynamically loaded application.

FIG. 6 is a flow diagram of a process for detecting events and/or actions based on received information from a dynamically loaded application.

FIG. 7 is a flow diagram of a process for a dynamically loaded application to receive messages from an agent terminal.

### DETAILED DESCRIPTION

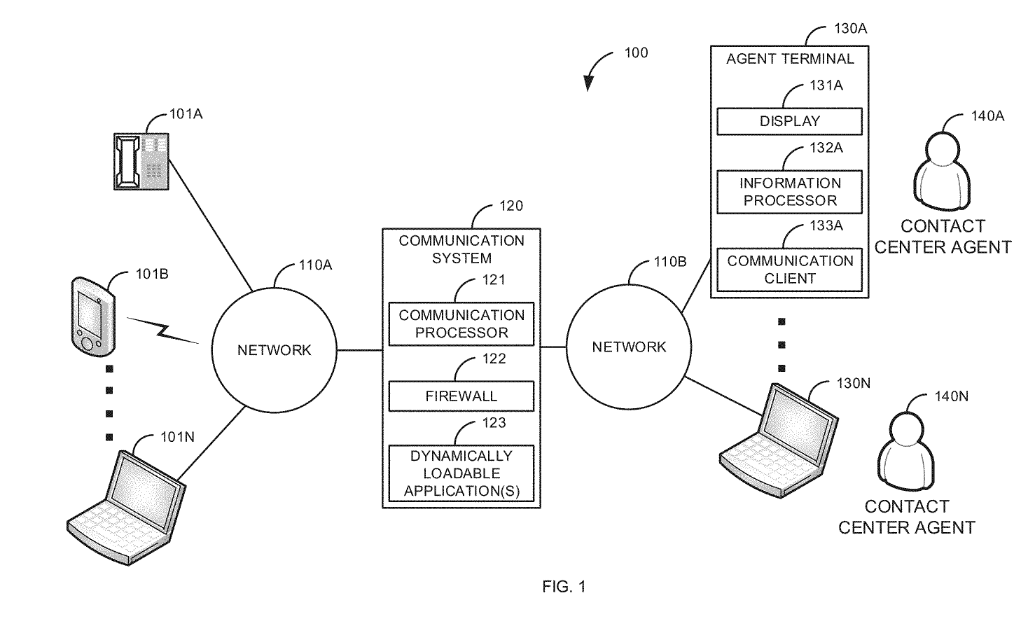

FIG. 1 is a block diagram of a first illustrative system 100 for managing integration between dynamically loaded applications 123 and agent terminals 130A-130N. The first illustrative system 100 comprises communication endpoints 101A-101N, a networks 110A-110B, a communication system 120, and agent terminals 130A-130N. In addition, contact center agents 140A-140N are shown at the agent terminals 130A-130N.

The communication endpoints 101A-101N can be or may include any communication endpoint device that can communicate on the network 110A, such as a Personal Computer (PC), a telephone, a video system, a cellular telephone, a Personal Digital Assistant (PDA), a tablet device, a notebook device, a smartphone, and/or the like. The communication endpoints 101A-101N are devices where a communication sessions ends. The communication endpoints 101A-101N are not network elements that facilitate and/or relay a communication session in the network, such as a communication manager or router. As shown in FIG. 1, any number of communication endpoints 101A-101N may be connected to the network 110A.

The networks 110A-110B can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, a combination of these, and the like. The networks 110A-110B can use a variety of electronic protocols, such as Ethernet, Internet Protocol (IP), Session Initiation Protocol (SIP), Hyper Text Transport Protocol (HTTP), and/or the like. Thus, the networks 110A-110B are electronic communication networks configured to carry messages via packets and/or circuit switched communications. In one embodiment, the network 110A is the PSTN or the Internet and the network 110B is a private network.

The communication system 120 can be or may include any hardware coupled with software that can route and manage communications between the communication endpoints 101A-101N and the agent terminals 130A-130N, such as, a Private Branch Exchange (PBX), a session manager, a communication manager, a router, a proxy server, and/or the like. The communication system 120 can route/manage various types of communication sessions, such as voice communication sessions, video communication sessions, multi-media communication sessions, virtual reality communication sessions, text communication sessions, Instant Messaging (IM) communication sessions, chat communication sessions, email communications, and/or the like.

In one embodiment, the communication system 120 may be part of a contact center. The communication system 120 may be used to route incoming and/or outgoing calls to and from the contact center agents 140A-140N at the agent terminals 130A-130N. The routing in the contact center may be accomplished using known mechanisms, such as contact center queues and interactive voice response systems.

The communication system 120 further comprises a communication processor 121, a firewall 122, and dynamically loadable application(s) 123. The communication processor 121 can be or may include any hardware processor coupled with software that can manage and process various types of communications sessions. For example, the communication processor 121 may manage the establishment of a voice communication session between the communication endpoint 101A and the agent terminal 130A.

The firewall 122 can be or may include any software coupled with hardware that can provide protection services, such as a Network Address Translator (NAT), a Session Border Controller (SBC), a packet filtering firewall 122, and/or the like. The firewall 122 is used to protect unwanted access to the communication system 120/network 110B.

The dynamically loadable application(s) 123 can be or may include any software application that can be dynamically loaded to monitor/manage communications between the communication endpoints 101A-101N and the agent terminals 130A-130N. The dynamically loadable application(s) 123 may be a Session Initiation Protocol (SIP) Back to Back User Agent (B2BUA) that can be dynamically be inserted into a communication session. The dynamically loadable application(s) 123 can provide a variety of services to the agent terminals 130A-130N, such as a recording service, a call forwarding service, a call forking service, a contact information service, a call control service, a customer control service, a call blocking service, a call prioritization service, and/or the like. The dynamically loadable application(s) 123 may be loaded and/or unloaded dynamically in various ways, such as, based an event, a rule, an initiation of a communication session, a user action, an event in a communication session, an event in a media stream of a communication session, and/or the like.

The agent terminals 130A-130N can be or any include any device that can provide services to the contact center agents 140A-140N. The agent terminals 130A-130N may be the same as or similar to a communication endpoint 101. An agent terminal 130 may comprise multiple communication devices, such as a telephone and a personal computer.

The agent terminal 130A further comprises a display 131A, an information processor 132A, and a communication client 133A. The display 131A can be or may include any element capable of providing information via a display 131 to a user, such as, a touch screen, a plasma display, a Light Emitting Diode (LED) display, a Liquid Crystal Display (LCD), a cathode ray tube, a lamp, and/or the like.

The information processor 132A can be or may include any software capable of sending and receiving messages sent to and from the dynamically loadable application(s) 123. The information processor 132A can intercept specific messages sent from the dynamically loadable application(s) 123.

The communication client 133A can be or may include any hardware/software that is used to establish a communication session with one or more of the communication endpoints 101A-101N. In one embodiment, the communication client 133A is a SIP communication client that is used to establish a SIP communication session.

Although not shown for simplicity, the agent terminals 130A-130N typically comprises other elements, such as a speaker, a microphone, an accelerometer, a mouse, and/or the like. In addition, the agent terminal 130N may also comprises a display 131N, an information processor 132N, a communication client 133N, a speaker, a microphone, an accelerometer, a vibrator, a mouse, and/or the like.

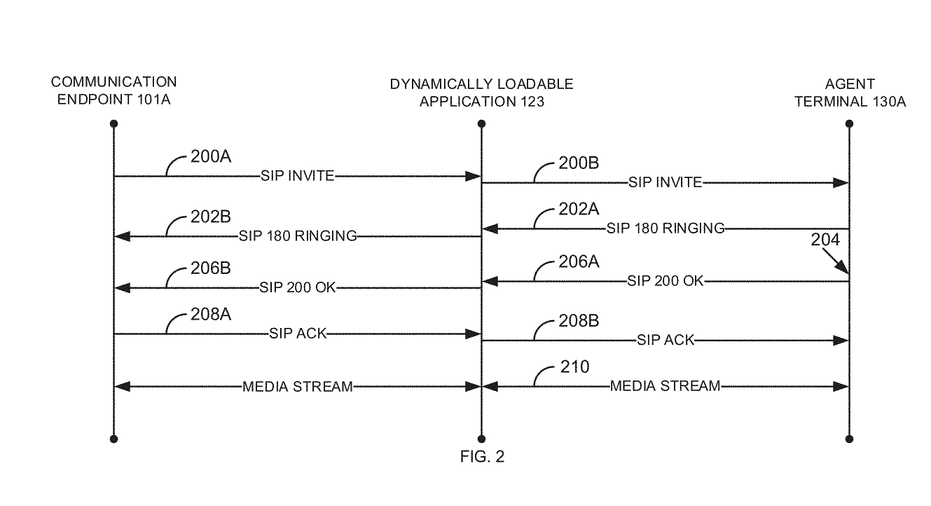

FIG. 2 is a flow diagram of an exemplary incoming SIP call flow in a contact center. Illustratively, the communication endpoints 101A-101N, the communication system 120, the communication processor 121, the firewall 122, the dynamically loadable application(s) 123, the agent terminals 130A-130N, the information processor 132A, and the communication client 133A are stored-program-controlled entities, such as a computer or microprocessor, which performs the method of FIGS. 2-7 and the processes described herein by executing program instructions stored in a computer readable storage medium, such as a memory (i.e., a computer memory, a hard disk, and/or the like). Although the methods described in FIGS. 2-7 are shown in a specific order, one of skill in the art would recognize that the steps in FIGS. 2-7 may be implemented in different orders and/or be implemented in a multi-threaded environment. Moreover, various steps may be omitted or added based on implementation.

The SIP messages described in FIG. 2 are standard well known SIP messages being implemented according to the SIP standards. Although not shown in FIG. 2, the process of FIG. 2 may include other contact center elements, such as a contact center queue where the user is placed in the contact center queue until the contact center agent 140A becomes available.

The process starts in step 200A when a user at the communication endpoint 101A initiates a call. For example, the user at the communication endpoint 101A initiates a voice call to the contact center. When the call is initiated, a SIP INVITE message is sent from the communication endpoint 101A in step 200A. The dynamically loadable application 123 (via the communication system 120) receives the SIP INVITE message 200A and forwards the SIP INVITE message 200A to the agent terminal 130A in step 200B.

In one embodiment, the agent terminal 130A may send a SIP 180 RINGING message in step 202A. The SIP 180 RINGING message is forwarded by the dynamically loadable application 123, in step 202B, to the communication endpoint 101A. In one embodiment, the agent terminal 130A may not send a SIP 180 RINGING message in step 202A.

The contact center agent 140A answers the call in step 204. In response, the agent terminal 130A sends, in step 206A, a SIP 200 OK message. The dynamically loadable application 123 forwards the SIP 200 OK message of step 206A to the communication endpoint 101A in step 206B. The communication endpoint 101A sends a SIP ACK message in step 208A. The dynamically loadable application 123 forwards the SIP ACK message of step 208A to the agent terminal 130A in step 208B. The communication endpoint 101A and the agent terminal 130A establish a media stream (e.g., a voice communication session), in step 210, using standard processes (e.g., using Real-Time Communication Protocol (RTCP)).

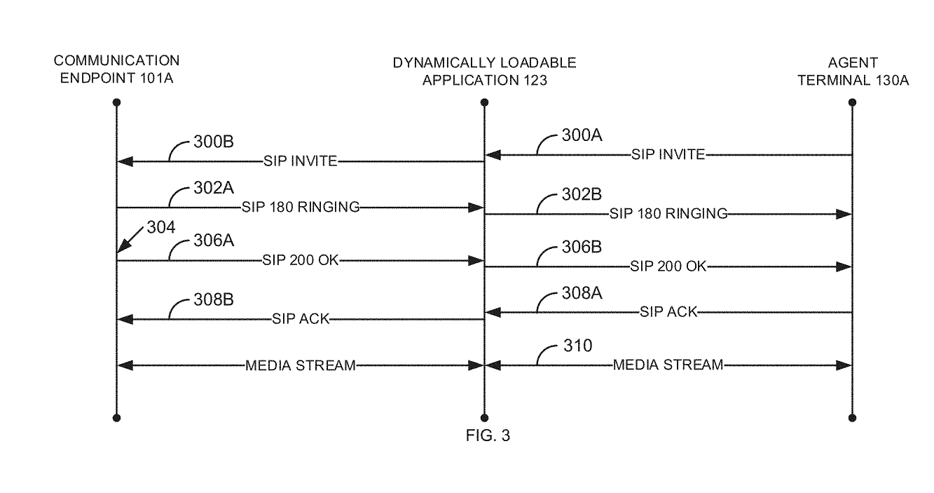

FIG. 3 is a flow diagram of an exemplary outgoing SIP call flow in a contact center. The process of FIG. 3 is typical SIP call flow for an outgoing call from the agent terminal 130A. The SIP messages described in FIG. 3 are standard well known SIP messages being implemented according to the SIP standards. Although not shown, the process of FIG. 2 may include other elements/processes, such as an auto-dialer that automatically initiates the outgoing call and establishes the outgoing call to the agent terminal 130A when a user at the communication endpoint 101A answers a call.

The process starts in step 300A when a user at a contact center agent 140A at the agent terminal 130A initiates a call. The agent terminal 130A sends a SIP INVITE message in step 300A. The dynamically loadable application 123 forwards the SIP INVITE message of step 300A to the communication endpoint 101A in step 300B. The communication endpoint 101A sends a SIP 180 RINGING message in step 302A. The dynamically loadable application 123 forwards the SIP 180 RINGING message of step 302A in step 302B to the agent terminal 130A. In one embodiment, the communication endpoint 101A may not send the SIP 180 RINGING message in step 302A.

A user at the communication endpoint 101A answers the call in step 304. In response, the communication endpoint 101A sends, in step 306A, a SIP 200 OK message. The dynamically loadable application 123 forwards the SIP 200 OK message of step 306A, in step 306B, to the agent terminal 130A. The agent terminal 130A sends a SIP ACK message in step 308A. The dynamically loadable application 123 forwards the SIP ACK message of step 308A to the communication endpoint 101A in step 308B. The communication endpoint 101A and the agent terminal 130A establish a media stream (e.g., a video communication session) in step 310 using standard processes (e.g., using Real-Time Communication Protocol (RTCP)).

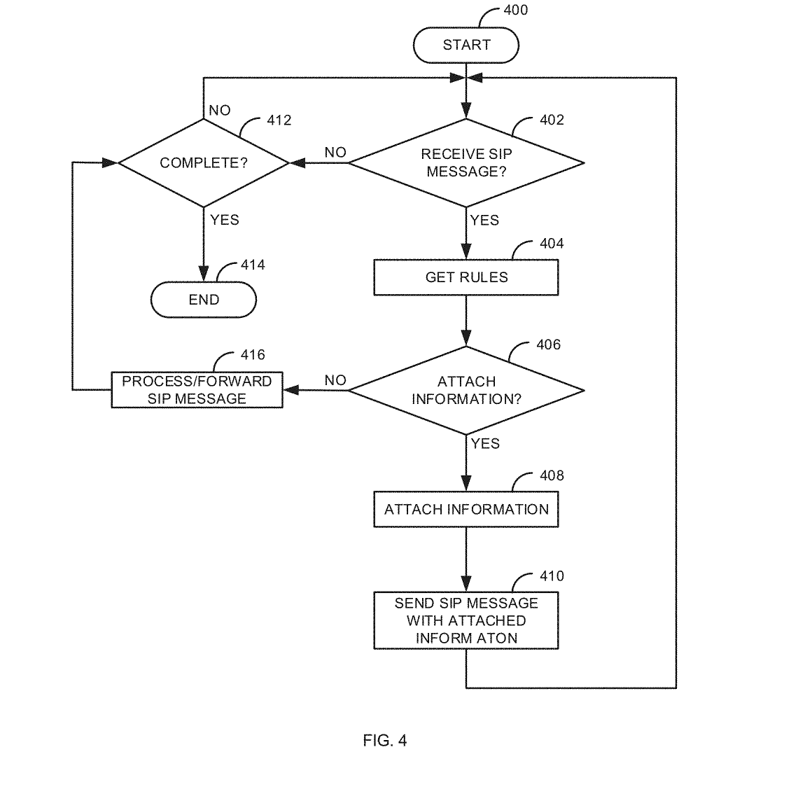

FIG. 4 is a flow diagram of a process for sending messages from a dynamically loaded application 123 to an agent terminal 130. The process described in FIG. 4 is based on the standard SIP call flows described in FIGS. 2-3 where a SIP communication session is being established between the communication endpoint 101A and the agent terminal 130A. However, the description of FIG. 4 is not limited to a single communication session, but may be used for multiple concurrent SIP communication sessions. The process of FIG. 4 is from the perspective of the dynamically loadable application 123.

The process starts in step 400. The dynamically loadable application 123 determines if a SIP message has been received in step 402. For example, the dynamically loadable application 123 may receive the SIP INVITE message of step 200A. If a SIP message has not been received in step 402, the process determines, in step 412 if the process is completed. For example, the communication session may have ended. If the process is completed in step 412, the process ends in step 414. Otherwise, the process repeats step 402.

If a SIP message has been received in step 402, the process goes to step 404. The type of SIP message that is received in step 402 may be any of the SIP messages described in FIGS. 2-3, such as, a SIP INVITE message, a SIP 180 RINGING message, a SIP 200 OK message, and a SIP ACK message. In addition, the SIP message of step 402 may be any other known standard SIP messages, such as, a SIP NOTIFY message, a SIP SUBSCRIBE message, a SIP PUBLISH message, a SIP TRYING message, and/or the like.

In response to receiving the SIP message in step 402, the dynamically loadable application 123 gets a set of rules in step 404. The rules may define specific SIP messages that are used to attach additional information for sending to one or more an agent terminals 130 involved in the communication session. For example, in one embodiment, the rules may only apply to an initial SIP INVITE message that is incoming from a communication endpoint 101 (e.g., the SIP INVITE message sent from the communication endpoint 101A in step 200A). In this case, additional information is attached to the SIP INVITE message based on receipt of the SIP INVITE message.

Alternatively, the rules may require multiple SIP messages to be received by the dynamically loadable application 123 before information is attached to a SIP message sent to the agent terminal 130. For example, using the call flow of FIG. 3, the rule may require that the SIP INVITE 300A has to be received from the agent terminal 130A (i.e., for the outgoing call from the agent terminal 130 or auto-dialer) and that the information is attached to the SIP 200 OK message 306B based on receiving the SIP 180 RINGING message (302A) and/or the SIP 200 OK message (306A) that is sent by a communication endpoint 101A.

In another embodiment, using the call flow for FIG. 2, the rule may require the SIP INVITE message (200A), the SIP 200 OK message (206A) and the SIP ACK message (208A) be received before the information is attached to the SIP ACK message (208B) that is sent to the agent terminal 130A. One of skill in the art would recognize that various combination of SIP messages may be defined in the rules of step 404 to determine specifically when to attach information to a SIP message.

Based on the rules of step 404, the dynamically loadable application 123 determines, in step 406, whether to attach information to the received SIP message. If the rules define to not attach information in step 406, the SIP message is processed and forwarded if necessary (for example as described in FIGS. 2-3). Otherwise, if the rules define to attach information in step 406, the information is attached to the SIP message in step 408. The information can be attached in various ways in step 408, such as, attaching the information in a new SIP header, attaching the information/instructions in a payload of a SIP message, attaching the information in an existing SIP header, attaching the information/instructions in a proprietary header, and/or the like.

The types of information attached to the SIP message is typically information that is used to display additional graphical user interface element(s) to the contact center agent 140 at the agent terminal 130. The information may allow the agent terminal 130 to display a new button, a new menu, a new menu item, a new pop-up window, a new label, a new animation, a new icon, and/or the like. For example, the dynamically loadable application 123 may be a recording application and the information may be to display a new button or menu item that allows the contact center agent 140 to record a voice or video communication session. Another example may be a new button is displayed to the contact center agent 140 that allows the contact center agent 140 to black list the caller. When the caller is black listed, calls are blocked from this caller in the future. Alternatively, the new button may be to indicate that the caller is a high priority caller for future calls. In one embodiment, the information is to display a new pop-up window or label that has information on the caller.

In one embodiment, the attached information may be used for making sounds and/or words. For example, the attached information may be to play a message or make a specific sound. In another embodiment, the attached information may be to cause a vibrator to vibrate. One of skill in the art would recognize that the use of graphical user interface, sound, and vibration elements may be used in various combinations.

The attached information/instructions may also request other types of information that is not associated with a graphical user interface, such as, a contact center agent identifier, accelerometer information, Global Positioning Satellite (GPS) information, an operating system used by the agent terminal 130, a type of display used in the agent terminal 130, a size of display used in the agent terminal 130, a picture of the contact center agent 140, and/or the like. For example, a contact center agent 140 may login to the agent terminal 130A where a contact center agent identifier is stored. The information may be a request for the agent terminal 130A to provide the contact center agent identifier based on the contact center agent 140 logging in to the agent terminal 130A.

The information that is attached, as one of skill in the art would recognize, may be in various formats. For example, a new SIP header may be defined as shown below for displaying a new menu on the agent terminal 130.

Application-Feature: namespace = <TEXT>; featureID = <text>;
displayFormat = <NONE | LABEL | ACTION>; caption=<TEXT>;
invokeURI=<APP://URI | HTTP://URI | HTTPS://URI>;
appParams = <TEXT>; os =<WIN | MAC | LINUX | ALL>;
screenPop = <TRUE | FALSE>; autoInvoke = <TRUE |
FALSE>

The “Application-Feature” parameter is the title of the SIP header.

The “namespace” parameter is the name used to group features in a submenu of the dropdown menu of the call appearance. In one embodiment, the “namespace” is the name of the dynamically loadable application 123.

The “featureID” parameter is a key to uniquely identify the feature in the menu list in order to make dynamic updates to the feature during the call.

The “displayFormat” parameter defines how the feature is displayed. The display format may define various formats. For example, the display format may have one of three formats as shown in the above example. “None” indicates that no text will be displayed for the feature allowing it only to be triggered by the “autoInvoke” parameter described below. “LABEL” is for an informative type of label that is only for display and no action is allowed in this feature (e.g., the contact center agent 140 cannot click on the label to cause an action). “Action” allows actions from the user. For example, the action may be to click on a button or to and trigger display of a Uniform Resource Identifier (URI).

The “caption” parameter is a string that labels the feature in the menu.

The “invokeURI” parameter allows the agent terminal 130 to execute a Uniform Resource Identifier (URI). The URI may be defined in various ways. For example, the URI may be Uniform Resource Locator (URL) that starts with “http://” or https://. The agent terminal 130 upon receiving the URL downloads the web page associated with the URL and displays the web page. Alternatively, a path to a local application/script may be sent, which starts with “app://”. The agent terminal 130 loads and invokes the local application based on the received local URI.

The “appParams” parameter is used in conjunction with invocation of a local application. The “appParams” parameter defines arguments for executing the local application.

The “os” parameter allows the agent terminal 130 to handle specifics of the operating system of the agent terminal 130 when launching an application. If the dynamically loadable application 123 sends multiple SIP headers for multiple operating system (e.g., Windows®, Linux®, etc.), the agent terminal 130 processes the SIP header for the particular operating system running on the agent terminal 130 and ignores the other operating system headers. Below are some exemplary operating system parameters

win: To identify a Windows® as the target operating system for the feature.

mac: To identify OS X or macOS system as the target operating system for the feature.

linux: To identity a Linux as the target operating system for the feature.

all: To identify all operating systems as target for the feature. This option is more likely to be used when the feature triggers an URL instead of an application/script.

The “screenPop” parameter is a true/false value that indicates if, when invoking a URI, an instance of a browser should be displayed. A false value invokes the URI in a silent mode. Silent mode is a mode where a browser is not opened until an URI is invoked. For example, when there is actually information that needs to be displayed.

The “autoInvoke” parameter is a true/false value that indicates if the feature will be automatically triggered upon receiving a call without any intervention from the contact center agent 140. Just because the “autoInvoke” parameter is set to “false” does not prevent the contact center agent 140 from invoking the feature at any time in the duration of the call.

If the above headers are not encrypted, the headers are open to different types of attacks. For example, a man in the middle attack may be used to injecting what looks like legitimate SIP header that uses a malicious URI executed by the agent terminal 130. To avoid these kinds of attacks, encryption, such as, Transport Layer Security (TLS) may be used to send and receive the attached SIP headers. If there is not an encrypted session (e.g. a TLS connection) the attached headers may be ignored.

An exemplary example of a SIP INVITE message that has an added SIP header is shown below. For example, the SIP INVITE message shown below may be the SIP INVITE message 200B in FIG. 2 with the attached SIP header shown in bold. The attached SIP header provides a pop-up window that is based on a downloaded web page from a URI.

```
    Contact: “Test1, Test1”
    <sip:64023@10.130.125.116:5061;transport=tls;gsid=b38ace70-3f79-11e6-
8d4a-005056b75ec2;
    epv=%3csip:64023%40siphr.avaya.com%3bgr%3db69d656f9e150d847548fced
fdf2e0a6%3e>;+avaya-cm-keepmpro= no User-Agent: Avaya Flare Engine/2.0.0 (Engine
GA-2.0.0.23; Windows NT 6.1, 32-bit) AVAYA-SM-7.0.0.1.700102
    Avaya CM/R017x.00.0.441.0 AVAYA-SM-7.0.0.1.700102 Allow: INVITE,
ACK, BYE, CANCEL, SUBSCRIBE, NOTIFY, REFER, INFO, PRACK, PUBLISH,
UPDATE Supported: 100rel, histinfo, join, replaces, sdp-anat, timer
    Application-Feature:
namespace=web;featureID=chat;displayFormat=ACTION;caption=chat;invokeURI=
“http://breeze.com/chat/63006”;os=ALL;screenPop=TRUE;autoInvoke=FALSE
    Via: SIP/2.0/TCP 10.130.125.115; branch=z9hG4bK575896365265091-AP;
ft=18
    Via: SIP/2.0/TCP 10.130.125.114:15060; rport=24373
```

Once the application feature header is received in the SIP INVITE message it is parsed and an Extended Markup Language (XML) representation is created and added by the information processor 132 to the internal events of the agent terminal 130. The internal events may be various kinds of events, such as to provide a chat session, a new button, a screen pop, invoking a URL, a call us button, displaying a customer web page, and/or the like. When the button is selected, the necessary features are then generated. For example, an initiation of a new chat session between the agent terminal 130 and the communication endpoint 101 may be established.

Once the information has been attached in step 408, the dynamically loadable application 123 sends the SIP message with the attached information, in step 410, to the agent terminal 130 and the process goes back to step 402.

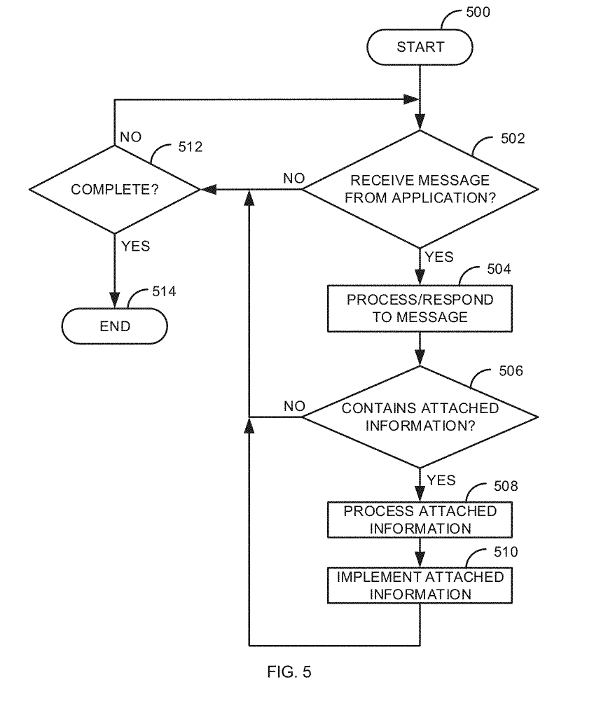

FIG. 5 is a flow diagram of a process for receiving messages from a dynamically loaded application 123. The process of FIG. 5 is from the perspective of the agent terminal 130.

The process starts in step 500. The communication client 133 determines if a message has been received from the dynamically loadable application 123 in step 502. For example, the message may be the SIP INVITE message 200B that is sent with the attached information of step 410. If a message is not received in step 502, the communication client 133 determines, in step 512, if the process is complete. For example, if the communication session has ended. If the process is complete in step 512, the process ends in step 514. Otherwise, if a message is received in step 502, the communication client 133 processes and responds (if necessary) to the received message in step 504. For example, if the message is the SIP INVITE of step 200B, as shown in FIG. 2, the agent terminal 130A sends a SIP 180 RINGING message of step 202A.

The communication client 133 determines, in step 506, if the received message contains attached information (i.e., the attached information sent in step 410). If the received message does not contain attached information in step 506, the process goes back to step 512 to determine if the process is complete. Otherwise, if the received message contains the attached information in step 506, the information processor 132 processes the attached information in step 508. The information processor 132 implements the attached information in step 510. For example, if the attached information is for displaying a pop-up window, the pop-up window is displayed (e.g., by downloading the pop-up window from a URI), in step 510, to the contact center agent 140 at the agent terminal 130 and the process goes back to step 512 to determine if the process is complete. Alternatively, the processing/implementing the attached information in steps 508-510 may be to play a message, make a sound (e.g., play a beep), vibrate a vibrator, retrieve information, and/or the like.

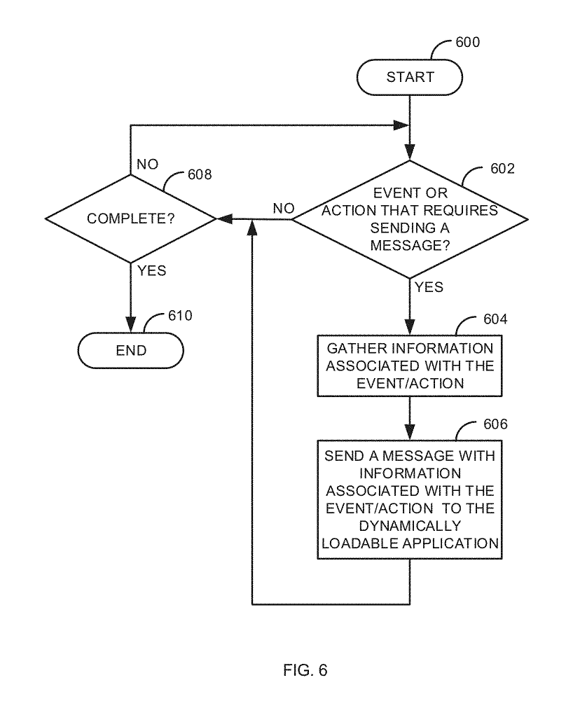

FIG. 6 is a flow diagram of a process for detecting events and/or actions based on received information from a dynamically loaded application 123. The process of FIG. 6 is from the perspective of the agent terminal 130.

The process starts in step 600. The information processor 132 determines, in step 602, if there is an event or action, based on the received information of step 510 that which requires a message to be sent to the dynamically loadable application 123. For example, the contact center agent 140 may have clicked (an event) on a button or menu item that is displayed based on the information implemented in step 510. An example of an action can be where the attached information requests information from the information processor 132. For example, the attached information may be to request an identifier of a contact center agent 140 currently using the agent terminal 130. Alternatively, the attached information may be associated with new verbal command spoken by a contact center agent 140.

If an event or action is not determined in step 602, the information processor 132 determines if the process is complete in step 608. For example, the communication session may have ended. If the process is complete in step 608, the process ends in step 610. If the process has not ended in step 608, the process goes back to step 602.

Otherwise, if an event or action is determined in step 602, the information processor 132 gathers, in step 604, information associated with the event or action. For example, the information processor 132 may get an identifier associated with a selected menu item. The information processor 132 sends, in step 606, a message with information associated with the event/action to the dynamically loadable application 123. The information processor 132 may send the message to the dynamically loadable application 123 in various ways. For example, in one embodiment, the information processor 132 may send the message of step 606 by sending an HTML message to the dynamically loadable application 123. Alternatively, the information processor 132 may send a message by adding a new SIP header to an existing SIP message similar to those described in steps 408 and 410. For example, the information processor 132 may add a new SIP header to the SIP 200 OK message 206A with a contact center agent identifier.

In one embodiment, the information processor 132 may send a new SIP message in step 606 that contains the information associated with the event or action. For example, the information processor 132 may send a new SIP INFO message with the information associated with the action or event. The process then goes back to step 608 to determine if the process is complete.

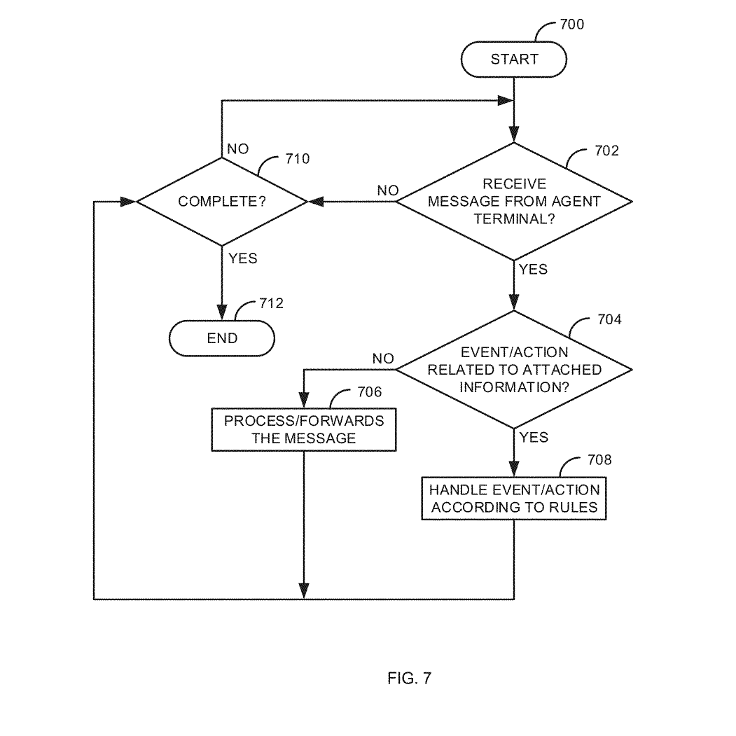

FIG. 7 is a flow diagram of a process for a dynamically loaded application 123 to receive messages from an agent terminal 130. The process of FIG. 7 is from the perspective of the dynamically loadable application 123.

The process starts in step 700. The dynamically loadable application 123 determines, in step 702, if a message has been received from the agent terminal 130. The received message can take different forms. The received message may be a regular SIP message (e.g., the SIP 200 OK message 206A), a SIP message sent for an event/action (sent in step 606), a HTTP response message (e.g., sent in step 606), and/or the like. If a message has not been received in step 702, the dynamically loadable application 123 determines, in step 710, if the process is complete. For example, if the communication session has ended. If the process is complete, the process ends in step 712. Otherwise, if the process is not complete in step 710, the process goes back to step 702 to wait to receive a message from the agent terminal 130.

If a message has been received from the agent terminal 130, in step 702, the dynamically loadable application 123 determines, in step 704, if the was sent by the agent terminal 130 in response to an event/action (sent in step 606 based on the attached information sent in step 410). If the message is not for an event/action, the dynamically loadable application 123 processes/forwards the message in step 706 and the process goes to step 710. For example, if the message is the SIP ACK message of step 208A, the dynamically loadable application 123 forwards the SIP ACK message (208B).

Otherwise, if the message is for an event/action in step 704, the dynamically loadable application 123 handles the event/action according to defined rules. For example, if the event was that the contact center agent 140 clicked on a record button, the dynamically loadable application 123 will start recording the communication session. The process then goes to step 710 to see if the process is complete.

The above descriptions are not limited to an agent terminal 130 in a contact center. In one embodiment, the agent terminal 130 may be a communication endpoint 101.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIV1926EJS™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network 110, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A system comprising:
a microprocessor; and
a computer readable medium, coupled with the microprocessor and comprising microprocessor readable and executable instructions that program the microprocessor to execute:
a dynamically loadable application that receives a first Session Initiation Protocol (SIP) message, attaches first information to the first SIP message, wherein the first information is for displaying one or more additional graphical user interface elements on a communication endpoint, wherein the one or more additional graphical user interface elements add new functionality to the communication endpoint, and sends the first SIP message with the attached first information to the communication endpoint.

2. The system of claim 1, wherein the dynamically loadable application receives from the communication endpoint, in response to sending the first SIP message, a second message in Hypertext Transport Protocol (HTTP), wherein the second message is received based on user input received from the one or more additional graphical user interface elements on the communication endpoint.

3. The system of claim 1, wherein the microprocessor readable and executable instructions program the dynamically loadable application to receive, from the communication endpoint, in response to sending the first SIP message, second information in a second SIP message, wherein the second information is received based on user input from the one or more additional graphical user interface elements on the communication endpoint.

4. The system of claim 3, wherein the first SIP message is a SIP INVITE message and the second SIP message is a SIP INFO message.

5. The system of claim 1, wherein the first SIP message is a SIP INVITE message, wherein the dynamically loadable application receives, from the communication endpoint, second information in a SIP 200 OK message, wherein the second information comprises a contact center agent identifier.

6. The system of claim 1, wherein the first information comprises a Uniform Resource Identifier (URI) and wherein the URI indicates at least one of: a remote web page to download for displaying the one or more additional graphical user interface elements and a path to a local application to be executed for displaying the one or more additional graphical user interface elements.

7. The system of claim 1, wherein the new functionality that is added to the communication endpoint is added without modification to existing software in the communication endpoint.

8. The system of claim 1, wherein the first information comprises a plurality of headers for a plurality of different operating systems and wherein the communication endpoint uses an individual header from the plurality headers based on a specific operating system supported by the communication endpoint.

9. The system of claim 1, wherein the first SIP message is one of a SIP 180 RINGING message, a SIP TRYING message, or a SIP 200 OK message that is received based on a SIP INVITE message sent from the communication endpoint or an auto-dialer.

10. A method comprising:
receiving, by a microprocessor, a first Session Initiation Protocol (SIP) message;
attaching, by the microprocessor, first information to the first SIP message, wherein the first information is for displaying one or more additional graphical user interface elements on a communication endpoint, wherein the one or more additional graphical user interface elements add new functionality to the communication endpoint; and
sending, by the microprocessor, the first SIP message with the attached first information to the communication endpoint.

11. The method of claim 10, further comprising: in response to sending the first SIP message, receiving, from the communication endpoint, a second message in Hypertext Transport Protocol (HTTP), wherein the second message is received based on user input received from the one or more additional graphical user interface elements on the communication endpoint.

12. The method of claim 10, further comprising: in response to sending the first SIP message, receiving, from the communication endpoint, second information in a second SIP message, wherein the second information is received based on user input from the one or more additional graphical user interface elements on the communication endpoint.

13. The method of claim 12, wherein the first SIP message is a SIP INVITE message and the second SIP message is a SIP INFO message.

14. The method of claim 10, wherein the first SIP message is a SIP INVITE message, wherein the dynamically loadable application receives, from the communication endpoint, second information in a SIP 200 OK message, wherein the second information comprises a contact center agent identifier.

15. The method of claim 10, wherein the first information comprises a Uniform Resource Identifier (URI) and wherein the URI indicates at least one of: a remote web page to download for displaying the one or more additional graphical user interface elements and a path to a local application to be executed for displaying the one or more additional graphical user interface elements.

16. The method of claim 10, wherein the first information comprises an auto-invoke instruction and wherein the auto-invoke instruction indicates if a feature is automatically invoked when a call is received.

17. The method of claim 10, wherein the first information comprises a plurality of headers for a plurality of different operating systems and wherein the communication endpoint uses an individual header from the plurality headers based on a specific operating system supported by the communication endpoint.

18. The method of claim 10, wherein the first SIP message is one of a SIP 180 RINGING message, a SIP TRYING or a SIP 200 OK message that is received based on a SIP INVITE message sent from the communication endpoint or an auto-dialer.

19. An agent terminal comprising:
a microprocessor;
a display, and
a computer readable medium, coupled with the microprocessor and comprising microprocessor readable and executable instructions that program the microprocessor to:
receive a Session Initiation Protocol (SIP) message with attached information, wherein the attached information is for displaying one or more additional graphical user interface elements in the display, wherein the one or more additional graphical user interface elements add new functionality to the communication endpoint;
add the one or more graphical user interface elements in the display based on the attached information;
receive an event from the at least one of the one or more additional graphical user interface elements based on the attached information; and
send a message to a dynamically loadable application based on the event.

20. The agent terminal of claim 19, wherein the SIP message is a SIP INVITE and where the sent message is an HTTP message.
